(19) United States
(12) Patent Application Publication
(10) Pub. No.: US 2024/0116172 A1
(43) Pub. Date: Apr. 11, 2024

(54) INTELLIGENT ROBOTIC SYSTEM FOR PALLETIZING AND DEPALLETIZING

(71) Applicant: Hitachi, Ltd., Tokyo (JP)

(72) Inventor: Yi-chu CHANG, Farmington Hills, MI (US)

(21) Appl. No.: 17/962,352

(22) Filed: Oct. 7, 2022

(51) Int. Cl. B25J 9/00

(52) U.S. Cl. CPC B25J 9/0096

(57) ABSTRACT

Aspects of the present disclosure involve systems and methods, which can include, for receipt of a pallet involving a plurality of objects, controlling a robotic arm to depalletize each of the plurality of objects from the pallet according to a position, orientation, and weight of the each of the plurality of objects retrieved from a database.

### BACKGROUND

### Field

The present disclosure is generally directed to robotic systems, and more specifically, to intelligent robotic systems for palletizing and depalletizing operations.

### Related Art

Palletizing and depalletizing technologies are commonly used in various areas, such as storage, warehouse with AS/RS (Automated Storage & Retrieval System), inventory, and e-Commerce. To keep balance and categorize items physically, these technologies must be customized according to properties of items, on-site space, and robot payload. However, while doing palletizing and depalletizing, items may be damaged or missed for some reasons.

In related art implementations, there can be a vision-assisted robotized depalletizer that uses a vision to capture position of each item relative to the pallet and identifies the item before picking the item. Finally, the vision system tells if the pallet is empty and whether the system is waiting for the next full pallet.

Related art implementations include a palletizer system with a vision system to capture the position and orientation of palletized items relative to the engagement position and orientation of the predetermined layer. Once both of the real position/orientation and predetermined position/orientation have been successfully captured and compared, the system can assure items are palletized to prevent issues.

### SUMMARY

Example implementations described herein are directed to a novel solution for palletizing and depalletizing.

Existing depalletizing solutions often require either human assistance, or advanced sensors combined with complex algorithms to handle challenging cases. On the other hand, the existing depalletizing solutions are complex to use, expensive to acquire, and still often fail to work robustly as the shape, the dimension, and the color of objects may change in day-to-day operations. Inappropriate palletizing and depalletizing may damage items or surrounding devices. Example implementations described herein are directed to addressing such issues.

The utilization of palletizing and depalletizing systems has been increasing with the development of factory automation. Such systems play an important role for managing inventory, warehouse, and other areas, and may reduce the cost and loss significantly if items are well-categorized. Recently, with the growth of on-line shopping, warehouse and inventory demand has risen, and the variety of items has increased. Palletizing and depalletizing have some issues that may increase processing time or damage items.

The first issue is to reduce cycle time as much as possible to improve efficiency for palletizing and depalletizing solutions. While doing palletizing operations, the dimensions of items are required to conduct the operations neatly and closely. In some cases, a vision system is used to measure the dimensions. Although accurate dimensions are obtained this way, the cycle time is thereby extended. To obviate this issue, example implementations described herein manage the dimensions of all items in a database, so that the robot can retrieve the dimensions from the database before picking (e.g., by scanning the barcode/quick release code on the item, radio frequency identification tag, or other technique in accordance with the desired implementation). However, in case the barcode or other technique fails/is unreadable, or the item is unknown, then the vision system will measure the dimensions. This will obviate unnecessary processing time and more efficiently facilitate palletizing operations.

The second issue is regarding the weight. Even though the pallet on the bottom is stiff and reliable, it might cause issues while being moved by a forklift due to unbalance in weight. In example implementations described herein, the system weights each item while picking them and then decides where to put each item. If there are many items in the same dimension, then the system will put the item in right position according to the weight. Weight, position, and orientation will be recorded in the database. Thus, the pallet can be balanced with an acceptable weight.

The third issue is to remember how to pick each item. Some items are not internally balanced, so it might be dangerous to pick such items up from the center point. However, the example implementations described herein record the suggested picking position to pick in the database, and the robot can follow the gripping instruction to prevent failure from gripping or damage.

The proposed intelligent palletizing and depalletizing system not only reduces the cycle time, but also assures the safety and quality of the entire pallet and each item. In addition, the system can provide suggestions in case the user ignores or forgets anything regarding the information of each item by accident.

In the example implementations of the present disclosure, a vision system is not only used to capture positions of all items, but also to measure the dimension of an item in case this item is unknown and the dimension is not in our database. In general, this vision system scans a barcode on the item and then the information of this item will be sent to a robot/controller. Then the robot knows how and where to pick/place the item.

As a result, the present disclosure can have the following advantages. Information regarding each item (e.g., position, dimension, etc.) can be stored and reference by the depalletizer system before the picking operation. Further, the position recorded during the palletization operation can be used as a reference for a robot before conducting pickup operations to prevent any misses/issues during the depalletization operation.

In the example implementations described herein, the information associated with the palletized items, such as position and orientation, can be retrieved from the database unless it is unknown. In addition, during palletizing and depalletizing operations, the robot will ensure that the position and orientation are identical and consistent to the database information. The proposed system can provide suggestions due to weight or dimension unbalance in weight.

For the database as described in example implementations herein, each item is recorded (e.g., dimension, position, and orientation) to allow for easier palletizing operations, and the real position/orientation relative to the predetermined position/orientation from the database may not always be identical, but the system can provide suggestions to handle some cases, such as unbalance in weight.

Through example implementations described herein, cycle time can be reduced by avoiding unnecessary processes. Items need to be put in specific positions according to their dimensions for the palletization operations. However, in some use cases, the system needs to measures the dimension while the robot picks up the item. That may increase the cycle time and cause potential issues. In example implementations described herein, most/all information can be managed in the database, including dimensions, so the system can know the dimension immediately from the database information (e.g., retrieved from scanning a barcode/QR code on the item). Accordingly, the robot can easily and quickly place the item in the correction position without redundant consumption of processes and time.

Through example implementations described herein, the weight balance can be maintained. Some items have the same dimensions but may have a huge difference in weight. If the system does not know the weight while conduct palletizing operations, it may cause an unbalance in weight, which can cause damage to the pallet. Further, items may also get damaged while the entire pallet moves. In the proposed method, the system records what items are to be placed on the pallet as well as the weight of the entire item/box in the database, so that the robot knows the approximate weight of the pallet and each item even before picking (e.g., by scanning a barcode/QR code on the item/box). The robot has a built-in weight sensor, so the system weighs each item and revises the weight data in the database if needed. Therefore, the system can maintain the balance in weight and prevent damage by receiving and managing weight data in the database. In addition, in some cases, the center of mass is not at the center, which means that the gripping position may need to be shifted to assure a static mode during picking. The center of mass can be located after packing the pallet and stored in the database. Then system can generate and subsequently follow picking instructions/suggestions to pick and prevent damage or droppage during picking.

Through example implementations described herein, information can be shared between the palletizer and the depalletizer. The system records most information of each item during palletization operations, such as dimension, position, orientation, and weight. However, if a depalletizer does not have such information available, it may be difficult to locate each item and decide how to pick and depalletize the pallet. The robot may crash or damage items if the robot picks from the wrong position. In example implementations described herein, information obtained from palletizing operations will be stored in cloud database and shared with a depalletizer. Thus, the depalletizer knows how and what to pick after referencing such information (e.g., position, dimension, and weight). Robot may change the appropriate gripper to handle specific items or boxes to achieve a goal of an intelligent palletizing and depalletizing robotic system.

Aspects of the present disclosure can involve a method, which can involve, for receipt of a pallet comprising a plurality of objects, controlling a robotic arm to depalletize each of the plurality of objects from the pallet according to a position, orientation, and weight of the each of the plurality of objects retrieved from a database.

Aspects of the present disclosure can involve a computer program, storing instructions for executing a process, the instructions involving, for receipt of a pallet comprising a plurality of objects, controlling a robotic arm to depalletize each of the plurality of objects from the pallet according to a position, orientation, and weight of the each of the plurality of objects retrieved from a database. The computer program and instructions can be stored on a non-transitory computer readable medium and executed by one or more processors.

Aspects of the present disclosure can involve an apparatus, which can involve a processor, configured to, for receipt of a pallet comprising a plurality of objects, control a robotic arm to depalletize each of the plurality of objects from the pallet according to a position, orientation, and weight of the each of the plurality of objects retrieved from a database.

### BRIEF DESCRIPTION OF DRAWINGS

FIG. 1 illustrates an overview of the proposed palletizing and depalletizing system, in accordance with an example implementation.

FIG. 2 illustrates the communication architecture over all devices of the system, in accordance with an example implementation.

FIG. 3 illustrates the flowchart of the palletizing system procedure in a normal use case, in accordance with an example implementation.

FIG. 4 illustrates palletized items on a pallet according to the item dimensions, in accordance with an example implementation.

FIG. 5 illustrates an example of palletized items being located at specific positions depending on the weight of each item to manage the pallet balance, in accordance with an example implementation.

FIG. 6 illustrates the flowchart of the intelligent palletizing method according to weight of each item, in accordance with an example implementation.

FIG. 7 illustrates the communication between a palletizer, a depalletizer, and shared cloud database, in accordance with an example implementation.

FIG. 8 illustrates the flowchart of the palletizer working procedure in FIG. 7, in accordance with an example implementation.

FIG. 9 illustrates the flowchart of the depalletizer working procedure in FIG. 7, in accordance with an example implementation.

FIG. 10 illustrates examples of database entries, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

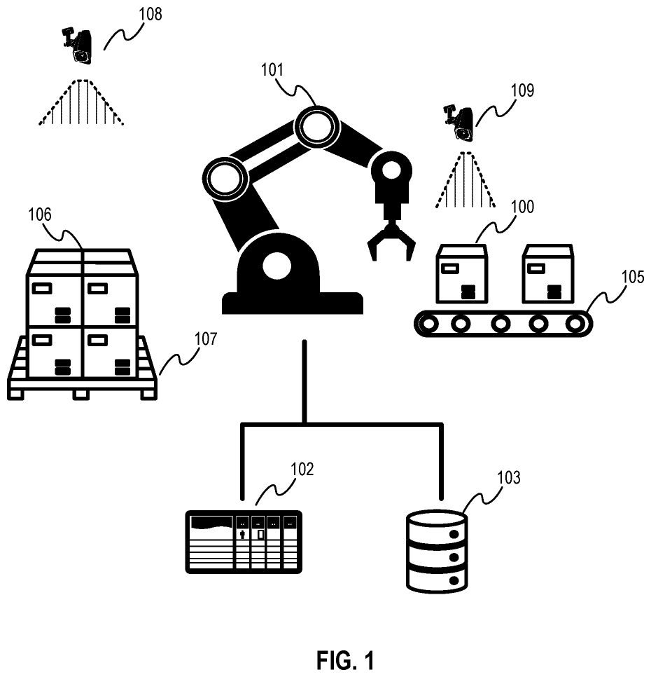

FIG. 1 illustrates an overview of the proposed palletizing and depalletizing system, in accordance with an example implementation. This system can involve a robot 101 configured to pick items 100 from a conveyor 105 and then conduct palletizing operations 106 on the pallet 107. In addition, there is a sensor/vision system 108 to capture the position and the orientation of a pallet and each item of the pallet. Before being picked up by the robot, a scanner (e.g., barcode/QR code, RFID scanner) 109 is used to scan an item to retrieve information regarding the item. The robot, vision, and scanner are controlled by a controller 102. All data/information regarding each item are stored in a database 103.

Items 100 arrive from the conveyor 105, and the robot 101 can conduct palletizing operations to place on pallet 106. Further, robot 101 can also depalletize items on the pallet 106 and place them on the conveyor 105 depending on the desired implementation. Sensors 108, 109 are used to determine the location of the pallet, as well as the location of the items. Robot 101 executes according to instructions from the controller 102, and retrieve/store information in the database 103.

Palletizing/depalletizing can depend on the size of the item portion(s) in the pallet as well as the pallet itself. Typical sizes can include 2×2 item arrangements, 2×3, or 3×4. The robot then scans information (e.g. barcode, QR code, RFID tag) to obtain information as needed, such as the size, weight and the internal contents, type of item, and when it was palletized from the database 103. Depending on the desired implementation, the information can include the order and instruction to depalletize, and where to place the item.

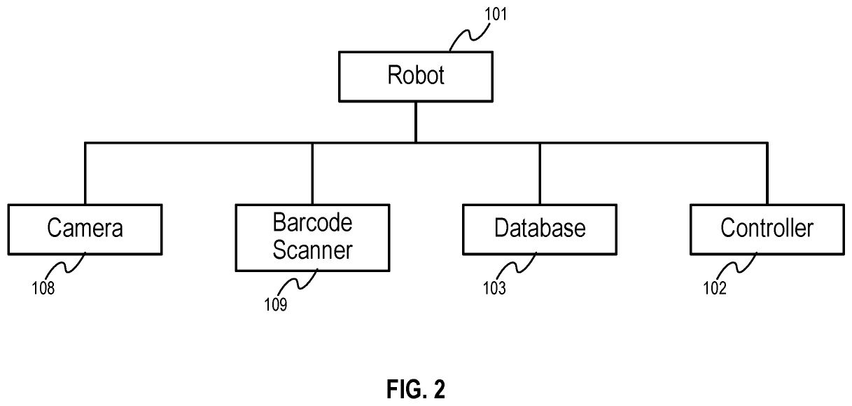

FIG. 2 illustrates the communication architecture over all devices of the system, in accordance with an example implementation. The robot 101, controller 102, camera vision system 108, scanner 109, and database system 103 are able to communicate among one another to share data and information as needed.

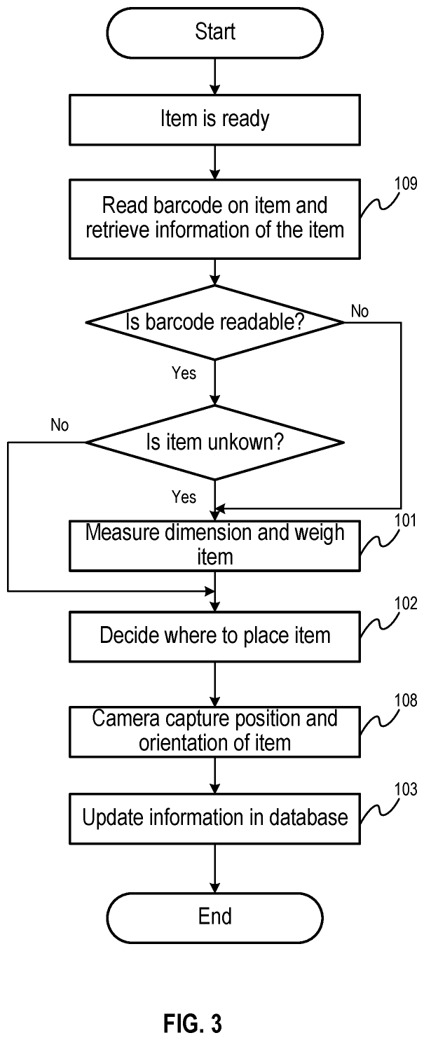

FIG. 3 illustrates the workflow of the palletizing system procedure in a normal use case, in accordance with an example implementation. Once an item is ready, the scanner 109 scans the item (e.g., scans the barcode, QR code, RFID tag) and then the system retrieves all related information from the database 103. When the robot 101 picks the item, it will weigh the item with a built-in or external weighing sensor as needed. The controller 102 decides where to place the item after retrieving all information of the item. The vision system 108 captures the position and orientation, and then the information will be updated in database 103. Then the cycle is completed.

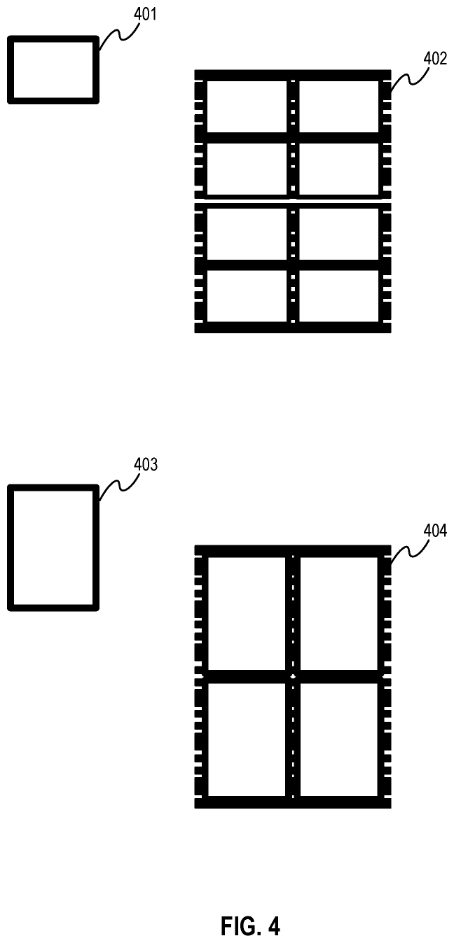

FIG. 4 illustrates palletized items on a pallet according to the item dimensions, in accordance with an example implementation. For a small item 401, the pattern 402 is one example for palletizing (e.g., 2×4); for a larger item 403, the pattern 404 is one example for palletizing (e.g., 2×2).

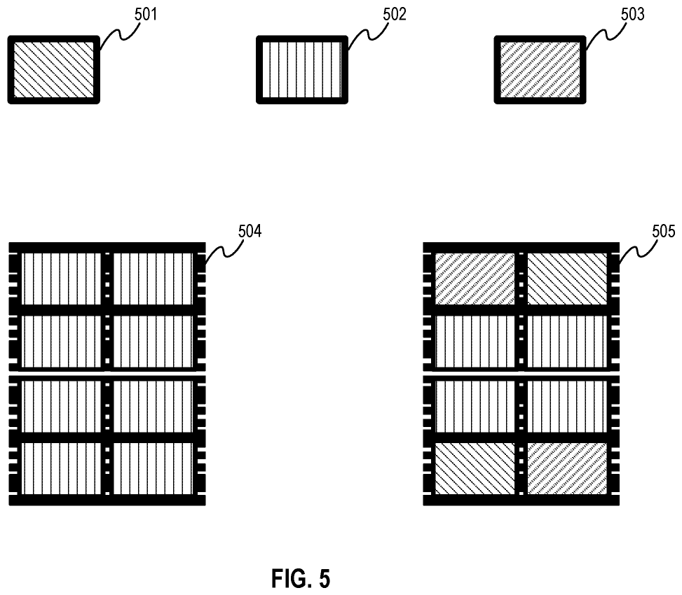

FIG. 5 illustrates an example of palletized items being located at specific positions depending on the weight of each item to manage the pallet balance, in accordance with an example implementation. In this figure, three items have the same dimension but have different weights. Item 501 is light, item 502 is median, and item 503 is heavy. If all items have the same weight or only slight differences in weight, the system may create a pattern 504. However, if each item has a large different from other items in weight, the system may assign specific positions for the items. For example, in pattern 505, there are three kinds of items and the system arranges the positions of the items to keep the entire pallet in balance.

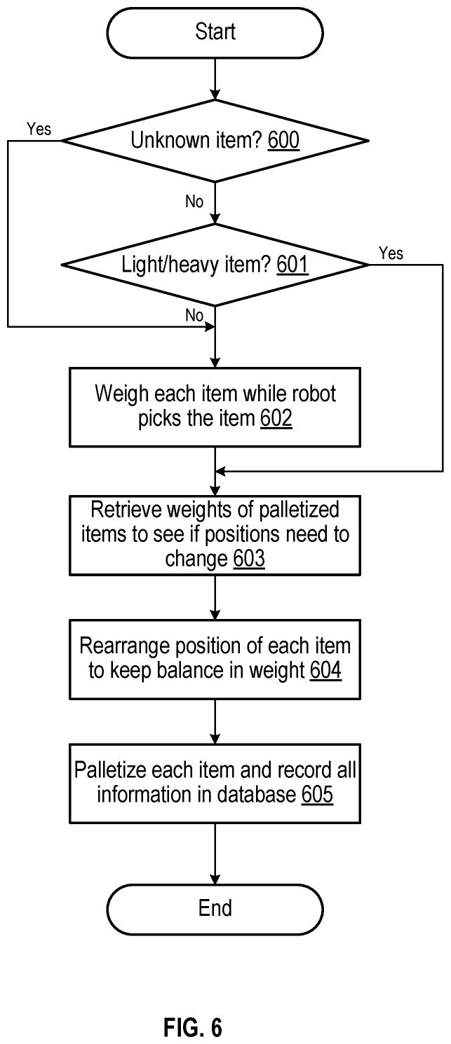

FIG. 6 illustrates the flowchart of the intelligent palletizing method according to weight of each item, in accordance with an example implementation. At 600, a determination is made as to whether the idem is unknown. If so (yes), then the flow proceeds to 602, otherwise (No), the flow proceeds to 601 to process the item. At 601, a determination is made as to whether the coming item is lighter or heavier than previously processed items. If not (No) the flow proceeds to 602, otherwise (Yes) the system will assign to specific or even rearrange the entire pallet to keep the balance even though the cycle time will be significantly increased. The rearrangement is conducted to maintain the weight balance as well as prevent damage to items.

At 602, the robot weighs the unknown item when picking the item. At 603, weights of palletized items are retrieved to determine if the positions need to change. At 604, the position of each item is thereby rearranged to maintain the weight balance based on the retrieved weight. At 605, the items are all palletized, wherein information for each item (e.g., position, weight, orientation) are then recorded into the database.

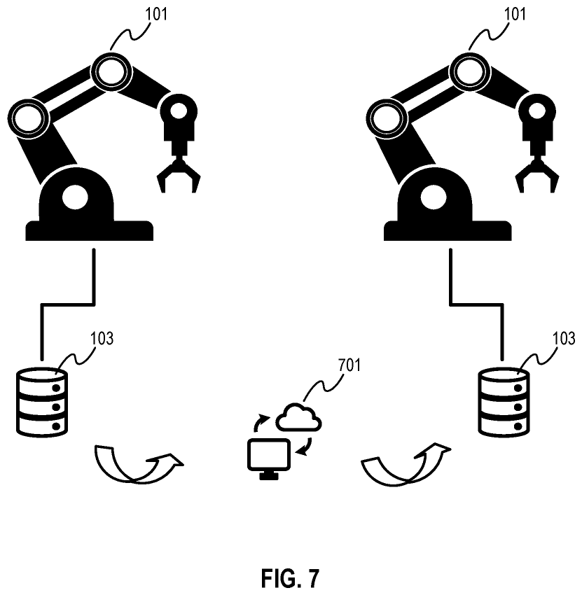

FIG. 7 illustrates the communication between a palletizer, a depalletizer, and shared cloud database, in accordance with an example implementation. Each of the palletizer and depalletizer systems have a robot 101 and a corresponding database 103. However, the palletizer and depalletizer systems share data via cloud database system 701. Therefore, once a palletizer completes the operations and submits information associated with a pallet to the database, the information will be shared with a depalletizer that will depalletize this pallet. Then the depalletizer knows all information and/or picking instruction.

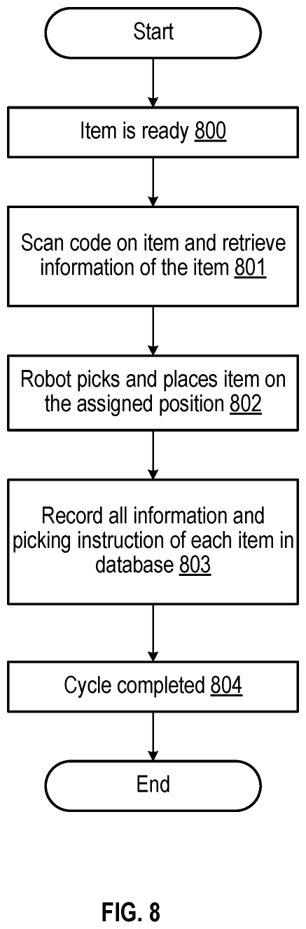

FIG. 8 illustrates the flowchart of the palletizer working procedure in FIG. 7, in accordance with an example implementation. The system records all information of the entire pallet to database to share with a depalletizer. At 800, the item is provided to be palletized by the palletizer. At 801, the code (e.g., barcode, RFID code, QR code) is read by the scanner and information is retrieved accordingly. At 802, the robot picks the item and place the item on the assigned position. At 803, the system records all information and picking instruction of each item in the database. At 804, the cycle is thereby completed.

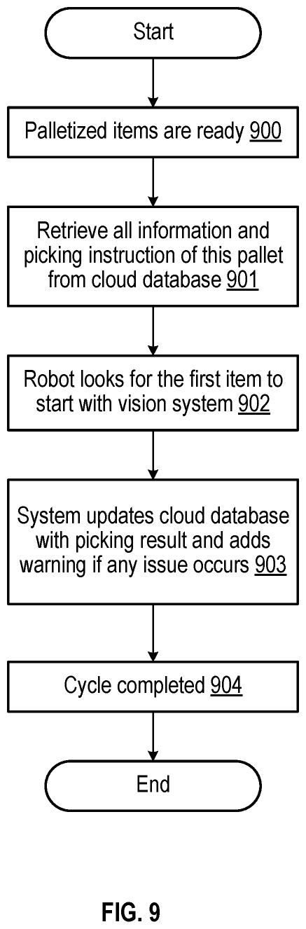

FIG. 9 illustrates the flowchart of the depalletizer working procedure in FIG. 7, in accordance with an example implementation. Before doing depalletizing, the system retrieves all information regarding this pallet from the database and then follows picking instruction to depalletize each item. However, if there are any unexpected issues or alarms, the system will update the database after the issues or alarms are cleared.

At 900, the palletized items are provided to the depalletizer to be ready for the depalletization operation. At 901, the information and picking instruction for the pallet is retrieved from the cloud database. At 902, the robot looks for the first item to start with their vision system. At 903, the system updates the cloud database with the picking result and adds a warning if any issue occurs. At 904, the cycle is thereby completed.

Through the example implementations described herein, the proposed intelligent palletizing and depalletizing system can be applied to most inventory and warehouse with an automatic storage and retrieval (AS/RS) system. With the growth of online shopping and the rise of labor costs, highly automated warehouse and e-commerce systems will become more developed. The proposed solution can be integrated in a system with multiple warehouses.

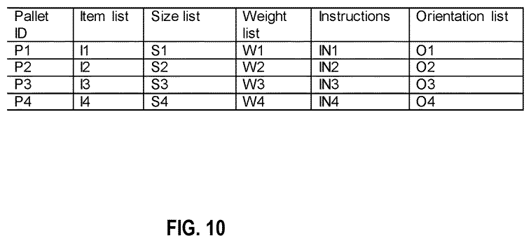

FIG. 10 illustrates examples of database entries, in accordance with an example implementation. Examples of database entries can include an identifier for the pallet, the item list (e.g., list of scan codes in the pallet and/or type of item), size list (e.g., dimensions of each item), weight list (e.g., weight of each item), instructions for palletizing/depalletizing each item, and orientation of each item.

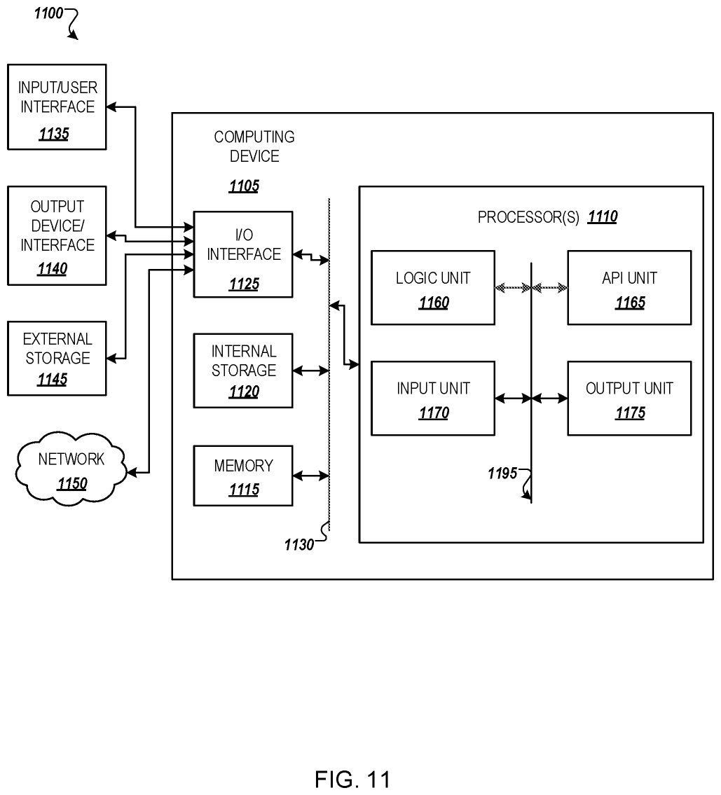

FIG. 11 illustrates an example computing environment with an example computer device suitable for use in some example implementations, such as a controller 102 as illustrated in FIG. 1. Computer device 1105 in computing environment 1100 can include one or more processing units, cores, or processors 1110, memory 1115 (e.g., RAM, ROM, and/or the like), internal storage 1120 (e.g., magnetic, optical, solid state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, 802.11×, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, input unit 1170, output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide output based on the calculations described in example implementations.

Processor(s) 1110 can be configured to execute methods or instructions which can include, for receipt of a pallet comprising a plurality of objects, controlling a robotic arm to depalletize each of the plurality of objects from the pallet according to a position, orientation, and weight of the each of the plurality of objects retrieved from a database.

Processor(s) 1110 can be configured to execute methods or instructions as described herein, wherein the controlling a robotic arm to depalletize each of the plurality of objects from the pallet according to a position, orientation, and weight of the each of the plurality of objects retrieved from a database can include retrieving the position, the orientation, and the weight of the each of the plurality of objects from the database; executing a vision system to identify the each object from the plurality of objects; depalletizing the identified each object from the plurality of objects according to the position, the orientation, and the weight; and updating the database with a result of the depalletizing of the identified each object.

Processor(s) 1110 can be configured to execute methods or instructions as described herein, wherein the methods and instructions further involve palletizing another plurality of objects, the palletizing the another plurality of objects involving controlling the robotic arm to palletize each of the another plurality of objects to another pallet according to the position, the orientation, and the weight of each of the another plurality of objects.

Processor(s) 1110 can be configured to execute methods or instructions as described herein, wherein the controlling the robotic arm to palletize the each of the another plurality of objects to another pallet according to the position, the orientation, and the weight of each of the another plurality of objects involves placing the each of the another plurality of objects to the another pallet; capturing, with a vision system, the position and the orientation of the each of the another plurality of objects; and updating the database with the captured position and the captured orientation for the each of the another plurality of objects.

Processor(s) 1110 can be configured to execute the methods or instructions as described herein, wherein the controlling the robotic arm to palletize the each of the another plurality of objects to another pallet according to the position, the orientation, and the weight of each of the another plurality of objects involves rearranging the each of the another plurality of objects on the another pallet based on the weight of the each of the another plurality of objects until weight on the another pallet is balanced.

Processor(s) 1110 can be configured to execute the methods or instructions as described herein, wherein the updating the database with a result of the depalletizing of the identified each object comprises updating the weight of the each of the plurality of objects for when the weight measured at depalletizing differs from the weight in the database.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a pallet comprising a plurality of objects:
controlling a robotic arm to depalletize each of the plurality of objects from the pallet according to a position, orientation, and weight of the each of the plurality of objects retrieved from a database.

2. The method of claim 1, wherein the controlling a robotic arm to depalletize each of the plurality of objects from the pallet according to a position, orientation, and weight of the each of the plurality of objects retrieved from a database comprises:
retrieving the position, the orientation, and the weight of the each of the plurality of objects from the database;
executing a vision system to identify the each object from the plurality of objects;
depalletizing the identified each object from the plurality of objects according to the position, the orientation, and the weight; and
updating the database with a result of the depalletizing of the identified each object.

3. The method of claim 1, further comprising palletizing another plurality of objects, the palletizing the another plurality of objects comprising:
controlling the robotic arm to palletize each of the another plurality of objects to another pallet according to the position, the orientation, and the weight of each of the another plurality of objects.

4. The method of claim 3, wherein the controlling the robotic arm to palletize the each of the another plurality of objects to another pallet according to the position, the orientation, and the weight of each of the another plurality of objects comprises:
placing the each of the another plurality of objects to the another pallet;
capturing, with a vision system, the position and the orientation of the each of the another plurality of objects; and
updating the database with the captured position and the captured orientation for the each of the another plurality of objects.

5. The method of claim 3, wherein the controlling the robotic arm to palletize the each of the another plurality of objects to another pallet according to the position, the orientation, and the weight of each of the another plurality of objects comprises rearranging the each of the another plurality of objects on the another pallet based on the weight of the each of the another plurality of objects until weight on the another pallet is balanced.

6. The method of claim 1, wherein the updating the database with a result of the depalletizing of the identified each object comprises updating the weight of the each of the plurality of objects for when the weight measured at depalletizing differs from the weight in the database.

7. A non-transitory computer readable medium, storing instructions for executing a process, the instructions comprising:
for receipt of a pallet comprising a plurality of objects:
controlling a robotic arm to depalletize each of the plurality of objects from the pallet according to a position, orientation, and weight of the each of the plurality of objects retrieved from a database.

8. The non-transitory computer readable medium of claim 7, wherein the controlling a robotic arm to depalletize each of the plurality of objects from the pallet according to a position, orientation, and weight of the each of the plurality of objects retrieved from a database comprises:
retrieving the position, the orientation, and the weight of the each of the plurality of objects from the database;
executing a vision system to identify the each object from the plurality of objects;
depalletizing the identified each object from the plurality of objects according to the position, the orientation, and the weight; and
updating the database with a result of the depalletizing of the identified each object.

9. The non-transitory computer readable medium of claim 7, the instructions further comprising palletizing another plurality of objects, the palletizing the another plurality of objects comprising:
controlling the robotic arm to palletize each of the another plurality of objects to another pallet according to the position, the orientation, and the weight of each of the another plurality of objects.

10. The non-transitory computer readable medium of claim 9, wherein the controlling the robotic arm to palletize the each of the another plurality of objects to another pallet according to the position, the orientation, and the weight of each of the another plurality of objects comprises:
placing the each of the another plurality of objects to the another pallet;
capturing, with a vision system, the position and the orientation of the each of the another plurality of objects; and
updating the database with the captured position and the captured orientation for the each of the another plurality of objects.

11. The non-transitory computer readable medium of claim 9, wherein the controlling the robotic arm to palletize the each of the another plurality of objects to another pallet according to the position, the orientation, and the weight of each of the another plurality of objects comprises rearranging the each of the another plurality of objects on the another pallet based on the weight of the each of the another plurality of objects until weight on the another pallet is balanced.

12. The non-transitory computer readable medium of claim 7, wherein the updating the database with a result of the depalletizing of the identified each object comprises updating the weight of the each of the plurality of objects for when the weight measured at depalletizing differs from the weight in the database.

13. An apparatus, comprising:
a processor, configured to, for receipt of a pallet comprising a plurality of objects:
control a robotic arm to depalletize each of the plurality of objects from the pallet according to a position, orientation, and weight of the each of the plurality of objects retrieved from a database.

14. The apparatus of claim 13, wherein the processor is configured to control a robotic arm to depalletize each of the plurality of objects from the pallet according to a position, orientation, and weight of the each of the plurality of objects retrieved from a database by:
retrieve the position, the orientation, and the weight of the each of the plurality of objects from the database;
executing a vision system to identify the each object from the plurality of objects;
depalletizing the identified each object from the plurality of objects according to the position, the orientation, and the weight; and
updating the database with a result of the depalletizing of the identified each object.

15. The method of claim 1, further comprising palletizing another plurality of objects, the palletizing the another plurality of objects comprising:
controlling the robotic arm to palletize each of the another plurality of objects to another pallet according to the position, the orientation, and the weight of each of the another plurality of objects.

16. The method of claim 3, wherein the controlling the robotic arm to palletize the each of the another plurality of objects to another pallet according to the position, the orientation, and the weight of each of the another plurality of objects comprises:
placing the each of the another plurality of objects to the another pallet;
capturing, with a vision system, the position and the orientation of the each of the another plurality of objects; and
updating the database with the captured position and the captured orientation for the each of the another plurality of objects.

17. The method of claim 3, wherein the controlling the robotic arm to palletize the each of the another plurality of objects to another pallet according to the position, the orientation, and the weight of each of the another plurality of objects comprises rearranging the each of the another plurality of objects on the another pallet based on the weight of the each of the another plurality of objects until weight on the another pallet is balanced.

18. The method of claim 1, wherein the updating the database with a result of the depalletizing of the identified each object comprises updating the weight of the each of the plurality of objects for when the weight measured at depalletizing differs from the weight in the database.
